(19) United States
(12) Patent Application Publication
(10) Pub. No.: US 2001/0010489 A1
(43) Pub. Date: Aug. 2, 2001

(54) Automobile vehicle equipped with a "hands free" access system with antennas located in passenger grab handles

(76) Inventor: Xavier Baudard, Paris (FR)

Correspondence Address: Longacre & White, Suite 240, 6550 Rock Spring Drive, Bethesda, MD, 20817, US

(21) Appl. No.: 09/772,310

(22) Filed: Jan. 31, 2001

(30) Foreign Application Priority Data
Jan. 31, 2000 (FR) 0001190

(51) Int. Cl. H04B 1/00; G05B 23/00

(52) U.S. Cl. 340/5.72

(57) ABSTRACT

The automobile vehicle is equipped with a recognition device (1) controlling means of locking the doors of an automobile vehicle (V). This recognition device is capable of making remote data exchanges with an identification device (17) worn or carried by a user to enable access to the vehicle when the recognition device has authenticated the identification device. The recognition device is connected to at least one antenna (2, 3, 4, 5) located in a passenger grab handle (6, 8, 10, 12) inside the vehicle.

The invention relates to an automobile vehicle equipped with a “hands free” access system.

In this type of system, a recognition device, sometimes also called an identification device, is installed on the vehicle to control locking means for doors and other vehicle opening parts, this recognition device being capable of remote data exchanges with an identification device also called an “identifier” worn or carried by a user, to enable access to the vehicle when the recognition device has authenticated the identification device. Several antennas are usually distributed around the vehicle to enable a dialog between the recognition device and the identification device, to detect if an identification device is present outside the vehicle.

When the user has issued a control to lock the vehicle doors, for example by pressing on the button provided for this purpose on the outside door handle and then moves away from the vehicle, the system checks that the doors and other opening parts of the vehicle are automatically locked as soon as the user wearing the identification device has moved out of the coverage area of the said external antennas.

In the past, antennas were placed in outside door handles, in other words outside the door under fairly severe conditions.

The purpose of the invention is to propose a better location for these antennas.

The purpose of the invention is an automobile vehicle equipped with a recognition device for controlling locking devices for automobile vehicle doors, the said recognition device being capable of making remote data exchanges with an identification device worn or carried by a user to enable access to the vehicle when the recognition device has authenticated the identification device, the recognition device being connected to at least one antenna placed on the vehicle, characterized in that the antenna is located inside the vehicle in a passenger grab handle.

Grab handle is generally know as:

The handle usually located above a passenger side door at the front or back of the vehicle. In general, this type of handle is not fitted on the driver's door, or,

The handle located in the arm rest positioned on the interior side of a vehicle door.

With this arrangement, the environment of the antenna is less severe than outside the vehicle. A passenger grab handle is usually less frequently used than an outside door handle which reduces the risks of breaking the electrical link between the antenna and the recognition device. With this arrangement, the antenna is further away from metal parts of the vehicle than it is when it is placed in an outside door handle, and particularly an operating lever type door handle.

According to one particular embodiment of the vehicle according to the invention, one antenna is located in a grab handle on one side of the vehicle and another antenna is located in another grab handle on the other side of the vehicle, so that the identification device can be detected selectively according to whether it is on one or the other side of the vehicle if the two antennas have coverage areas that overlap on each side of the vehicle. This type of selectivity is useful since, for example, when the antenna located on the right side or the passenger side detects that an authorized user is approaching the vehicle from this side, it can control unlocking of doors on the passenger side only, and when the antenna on the left side or the driver's side of the vehicle detects that an authorized driver of the vehicle is moving towards the vehicle from the driver's side, it can unlock the door locks on the driver's side only (or on both sides). If the coverage areas of the two antennas overlap inside the vehicle, then it is possible to detect the identification device differently on whether it is inside or outside the vehicle.

According to one another embodiment of the vehicle according to the invention, one antenna is located in each grab handle of the vehicle, if the grab handle is to be considered as one or the other type. In the case of grab handles located above a passenger side door, there may be three antennas located in each grab handle in the vehicle, whereas in the case of the grab handles located in the arm rest of the door, there may be four antennas located in each grab handle.

One example embodiment of a vehicle equipped with a “hands free” access system according to the invention is described in further detail and illustrated on the drawings.

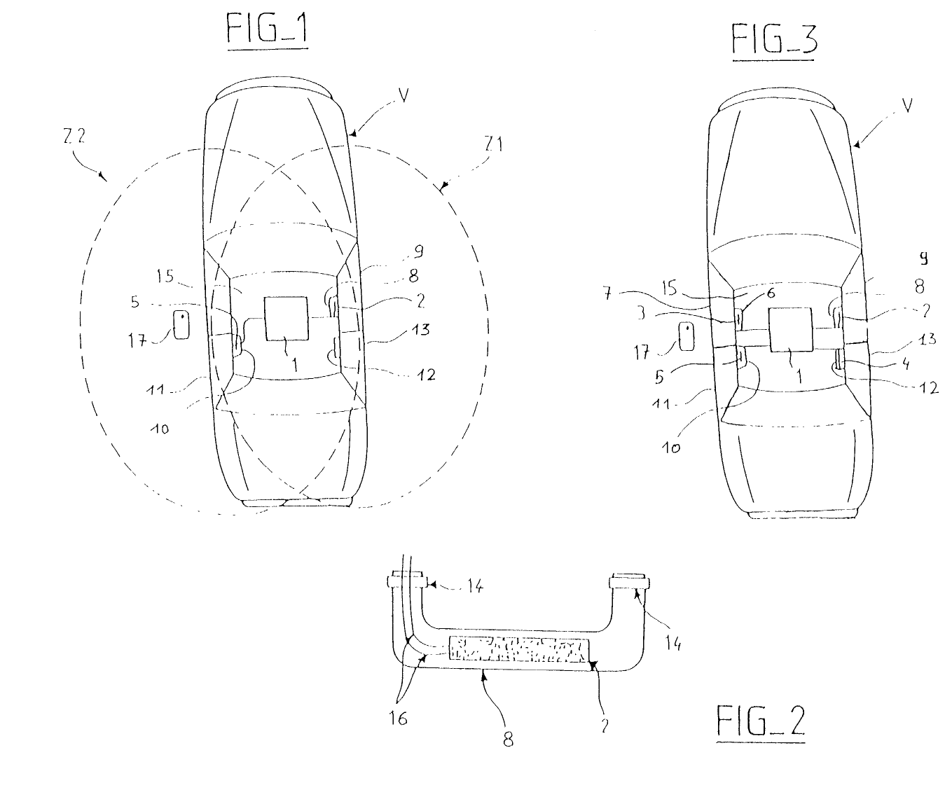

FIG. 1 shows a top view of a vehicle equipped with a “hands free” access system according to the invention.

FIG. 2 illustrates a passenger grab handle in which a “hands free” access system antenna is located.

FIG. 3 shows a top view of a vehicle equipped with a “hands free” access system according to another embodiment of the invention.

FIG. 1 shows a vehicle V equipped with a “hands free” access system, comprising a recognition device 1 connected to two antennas 2 and 5 located on the right and left sides of the vehicle V, respectively. More particularly, the antenna 2 is embedded in the passenger grab handle 8 located above the front right door 9 of the vehicle V and the antenna 5 is embedded in the passenger grab handle 10 located above the rear left door 11 of the vehicle V. It is clear that the antenna 2 could also be embedded in the passenger grab handle 12 above the right rear door 13 of the vehicle V.

As an example, FIG. 2 shows the antenna 2 that is embedded in the passenger grab handle 8. This grab handle 8 may be installed to pivot about the two axes 14 fixed on one side of the roof 15 of the vehicle V above the vehicle front right door 9. The electrical wires between the antenna 2 and the recognition device 1 are denoted 16.

FIG. 1 also shows the coverage areas Z1 and Z2 of the two antennas 2 and 5 as dashed lines, when they are powered at nominal power. Each of the two areas overlaps one side of the vehicle V and the two coverage areas overlap inside the vehicle. Consequently, if a user carrying or wearing an identification device 17 is in the position shown in FIG. 1 close to the antenna 5 and outside the vehicle V, he will be detected only by antenna 5. If the identification device 17 is located close to antenna 2 and outside the vehicle V, he will be detected only by antenna 2. If the identification device 17 is located inside the vehicle V, he will be detected by antenna 2 and by antenna 5. The recognition device 1 may thus selectively determine if the identification device 17 is located outside the vehicle on the right side, outside the vehicle on the left side, or inside the vehicle in order to be able to control appropriate functions for each case.

FIG. 3 shows a vehicle V equipped with a “hands free” access system, comprising a recognition device 1 connected to two pairs of antennas 2,4 and 3,5, each pair located on the right and left sides of the vehicle V, respectively. For each pair of antennas, the first antenna 2, 3 is embedded in the grab handles 8, 6 at the front of the vehicle whereas the second antenna 4, 5 of the pair is embedded in the grab handles 12, 10 at the back of the vehicle. The grab handles 6, 8, 10, 12 where the antennas 3, 2, 5, 4 are embedded, respectively, are grab handles located in the arm rest on the interior side of each door 7, 9, 11, 13.

Thus, in case of needs, it is possible to integrate a number of antennas higher than two in the grab handles located in the vehicle.

In this embodiment, four antennas are embedded in the respective grab handles which permits, as in the embodiment of FIG. 1, to determine where is located the identification device 17. In this case, it is possible to selectively determine if the identification device 17 is located outside the vehicle, on the right side at the front or at the back of the vehicle, outside the vehicle, on the left side at the front or at the back of the vehicle or inside the vehicle in order to be able to control appropriate functions for each case.

For some clarity reasons, the different coverage areas of the antennas 2, 3, 4, 5, when powered at nominal power, are not represented in FIG. 3 but the selectivity principle is the same as described in the embodiment of FIG. 1, with selectivity based on a higher number of areas. In addition to determine on which side of the vehicle is the user carrying or wearing the identification device 17, it is possible to determine if he is at the front or at the back of the vehicle.

In the case of antennas embedded in grab handles located above a side door of the vehicle, as described in the embodiment of FIG. 1, a grab handle located above the front left door, driver's door, of the vehicle can be provided and if needed, an antenna could be embedded in this grab handle.

1. An automobile vehicle equipped with a recognition device (1) controlling means of locking the doors of an automobile vehicle (V), the said recognition device being capable of making remote data exchanges with an identification device (17) worn or carried by a user to enable access to the vehicle when the recognition device has authenticated the identification device, the recognition device being connected to at least one antenna (2, 3, 4, 5) located on the vehicle, characterized in that the antenna is placed inside the vehicle in a passenger grab handle (6, 8, 10, 12).

2. The vehicle according to claim 1, wherein the grab handle (8, 10, 12) is located above a passenger side door at the front or back of the vehicle

3. The vehicle according to claim 1, wherein the grab handle (6, 8, 10, 12) is located in the arm rest positionned, in the vehicle, on the interior side of a vehicle door.

4. The vehicle according to one of claims 1 to 3 comprising at least two pair of antennas (2,4; 3,5), each pair of antennas is located on the right and left sides of the vehicle V, respectively, the first antenna (2, 3) of a pair being embedded in the grab handles (8, 6) at the front of the vehicle and the second antenna (4, 5) of a pair being embedded in the grab handles (12, 10) at the back of the vehicle.
